(19) United States
(12) Patent Application Publication
(10) Pub. No.: US 2003/0110685 A1
(43) Pub. Date: Jun. 19, 2003

(54) Floral container having a liner

(76) Inventor: Donald E. Weder, Highland, IL (US)

Correspondence Address: DUNLAP, CODDING & ROGERS P.C., PO BOX 16370, OKLAHOMA CITY, OK, 73114, US

(21) Appl. No.: 10/359,783

(22) Filed: Feb. 7, 2003

Related U.S. Application Data
(63) Continuation of application No. 09/989,809, filed on Nov. 20, 2001, now abandoned.
Application No. 09/989,809 is a continuation-in-part of application No. 09/464,753, filed on Dec. 16, 1999, now abandoned.

(51) Int. Cl. A01G 5/00; A47G 7/00

(52) U.S. Cl. 47/41.01

(57) ABSTRACT

A floral container for containing a floral grouping, the container constructed from a foam material having a cavity and a liner disposed within the cavity, the liner extending a distance from an upper end of the container. A method of use of the floral container is also disclosed.

### CROSS-REFERENCE TO RELATED APPLICATION

This application is a continuation of U.S. Ser. No. 09/989,809, filed Nov. 20, 2001, now abandoned; which is a continuation-in-part of co-pending U.S. application Ser. No. 09/464,753, filed Dec. 16, 1999, entitled “Floral Container Having A Liner”, now abandoned. The specification of which is hereby expressly incorporated by reference herein in its entirety.

### FIELD OF THE INVENTION

The present invention relates generally to floral containers used to contain floral groupings.

### BRIEF DESCRIPTION OF THE DRAWINGS

FIG. 1 is a partial cutaway, cross-sectional view of a floral container lined with a liner constructed in accordance with the present invention.

FIG. 2 is a perspective view of the floral container of FIG. 1.

FIG. 3 is a cross-sectional view of another floral container lined with a liner constructed in accordance with the present invention.

FIG. 4 is a partial cutaway, cross-sectional view of another floral container lined with a liner constructed in accordance with the present invention.

FIG. 5 is a partial cutaway, perspective view of the floral container of FIG. 4.

FIG. 6 is a partial cutaway, perspective view of another floral container constructed in accordance with the present invention.

FIG. 7 is a partial cutaway, cross-sectional view of another floral container constructed in accordance with the present invention.

FIG. 8 is a partial cutaway, perspective view of the floral container of FIG. 7.

FIG. 9 is a partial cutaway, cross-sectional view of another floral container constructed in accordance with the present invention.

FIG. 10 is a partial cutaway, perspective view of another floral container constructed in accordance with the present invention.

FIG. 11 is a partial cutaway, cross-sectional view of the floral container of FIG. 1 wherein a potting material and floral grouping are disposed within the liner.

FIG. 12 is a partial cutaway, cross-sectional view of the floral container of FIG. 4 wherein a potting material and floral grouping are disposed within the liner.

FIG. 13 is a partial cutaway, cross-sectional view of the floral container of FIG. 7 wherein a potting material and floral grouping are disposed within the liner.

FIG. 14 is a partial cutaway, cross-sectional view of the floral container of FIG. 9 wherein a potting material and floral grouping are disposed within the liner.

FIG. 15 is a partial cutaway, cross-sectional view of the floral container of FIG. 1 wherein the liner of the floral container has perforations therein.

FIG. 16 is a partial cutaway, cross-sectional view of the floral container of FIG. 4 wherein the liner of the floral container has perforations therein.

FIG. 17 is a partial cutaway, cross-sectional view of the floral container of FIG. 7 wherein the liner of the floral container has perforations therein.

FIG. 18 is a partial cutaway, cross-sectional view of the floral container of FIG. 9 wherein the liner of the floral container has perforations therein.

FIG. 19 is a perspective view of another embodiment of a floral container constructed in accordance with the present invention.

FIG. 20 is a perspective view of another embodiment of a floral container constructed in accordance with the present invention.

FIG. 21 is a perspective view of another embodiment of a floral container constructed in accordance with the present invention.

FIG. 22 is a perspective view of another embodiment of a floral container constructed in accordance with the present invention.

FIG. 23 is a perspective view of another embodiment of a floral container constructed in accordance with the present invention.

FIG. 24 is a perspective view of another embodiment of a floral container constructed in accordance with the present invention.

FIG. 25 is a perspective view of another embodiment of a floral container constructed in accordance with the present invention.

### DETAILED DESCRIPTION OF THE INVENTION

The present invention contemplates a method of containing a floral grouping within a floral holding material having a cavity formed therein. The floral holding material is lined with a liner into which a floral grouping is disposed.

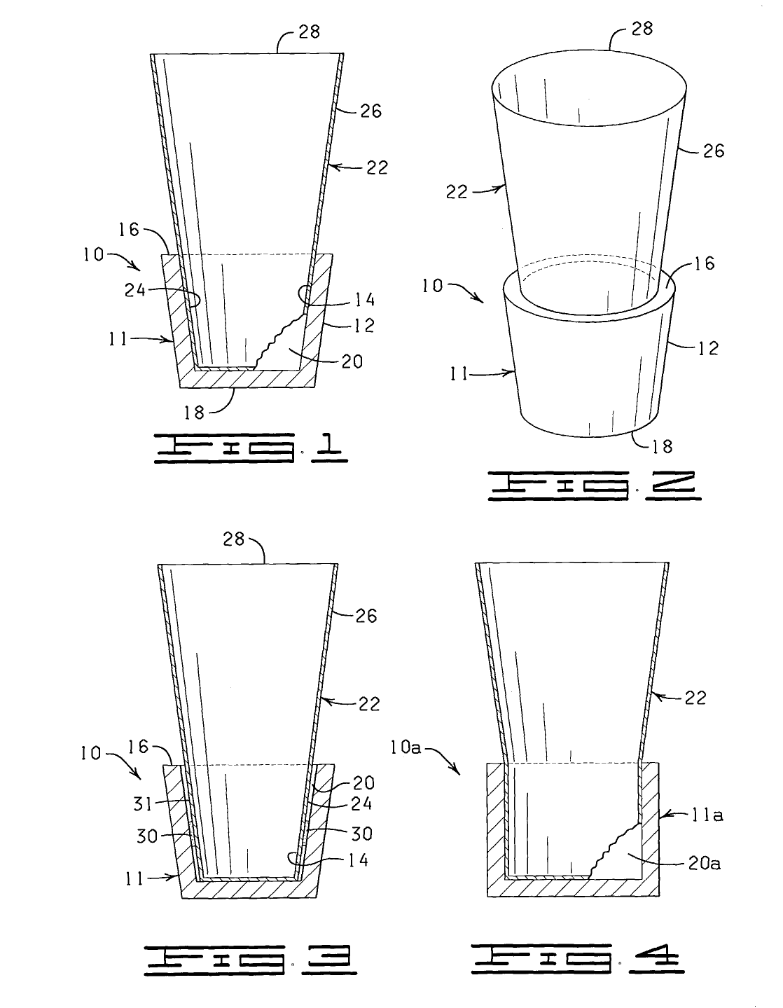

Shown in FIG. 1 and designated by the general reference number 10 is a floral container. The floral container 10 comprises a floral holding material 11 having an outer surface 12 and an internal surface 14. The floral holding material 11 has an upper end 16 and a lower end 18 and a cavity 20 defined by the internal surface 14 of the floral holding material 11. The floral holding material 11 shown in FIG. 1 has an inverted truncated frustoconical shape typical of a standard flower pot although the floral holding material 11 may be any shape desired in any particular application, for example spherical, rectangular, conical, cylindrical, vase-shaped or other geometric shapes and as described elsewhere. The floral container 10 further comprises a liner 22 disposed within the cavity 20 formed in the floral holding material 11. Thus, the liner 22, in cooperation with the floral holding material 11, can contain a floral grouping without any pot such as a separate flower pot, as described in more detail below.

The floral holding material 11 is constructed of a porous material and the outer surface 12 of the floral holding material 11 may include a water-impermeable layer comprised of one of any number of commercially available compounds which can be used to coat the outer surface 12 of the floral holding material 11 as long as the compound does not result in decomposition of the floral holding material 11. For example, the coating may be a commercially available polyurethane-type or polyester isocyanate compound. The coating may be moisture-curable. The water-impermeable layer may be produced by briefly heating the outer surface 12 of the floral holding material 11 to cause a hardened glaze.

The outer surface 12 of the floral holding material 11 may be undecorated or decorated (not shown). The decorations could be decorations with inks, ribbons, sequins, ceramics, sheets of material, plastic attachments, or any of a number of other decorative features.

The floral holding material 11 of the floral container 10 may be the type of material commonly referred to in the art as floral foam or Oasis™ or may be a compacted or molded fibrous organic material or other non-ceramic or non-plastic material which is capable of holding its predetermined shape and which is capable of receiving and supporting a floral grouping without a pot.

As shown in FIGS. 1 and 3, the liner 22 is disposed within the cavity 20 of the floral holding material 11. The liner 22 can be a sheet of material such as shown in U.S. Pat. No. 5,111,638 and which is well known to one of ordinary skill in the art. The liner 22 is provided with a lower portion 24 which lines the internal surface 14 defining the cavity 20 of the floral holding material 11, and an upper portion 26 which extends a distance above the upper end 16 of the floral holding material 11. The liner 22 has an upper end 28 which may be closed after a floral grouping is disposed within the liner 22.

Alternatively, the liner 22 may be a wrapper well known in the art as a sleeve which is a tubular wrapper having a closed or open lower end. Examples of sleeves are shown for example in U.S. Pat. No. 5,625,979, which is hereby expressly incorporated by reference herein.

Alternatively, the liner 22 may be a preformed pot cover of the type commercially available and known as a SPEED COVER and shown for example in U.S. Pat. No. 4,773,182, which is hereby expressly incorporated herein by reference.

In a preferred embodiment the upper portion 26 of the liner 22 is sized to substantially surround a floral grouping when a floral grouping is disposed within the liner 22. The upper portion 26 of the liner 22 may extend any distance above the upper end 16 of the floral holding material 11.

As shown in FIG. 3, the lower portion 24 of the liner 22 may be connected to the inner surface 14 of the floral holding material 11 by an adhesive or cohesive bonding material 30. When the bonding material is an adhesive, the adhesive may be disposed on either an outer surface 31 of the lower portion 24 of the liner 22, or on the internal surface 14 of the floral holding material 11, or both on the outer surface 31 of the lower portion 24 of the liner 22 and on the internal surface 14 of the floral holding material 11. When the bonding material 30 is a cohesive, it is generally disposed on both the internal surface 14 of the floral holding material 11 and on the outer surface 31 of the lower portion 24 of the liner 22, unless the bonding material 30 has the ability to bind directly to the internal surface 14 of the floral holding material 11. Any of the embodiments shown herein may have alternate versions characterized as having a liner connected via a bonding material to the floral holding material, such as the liner 22 connected to the floral holding material 11 as shown in FIG. 3.

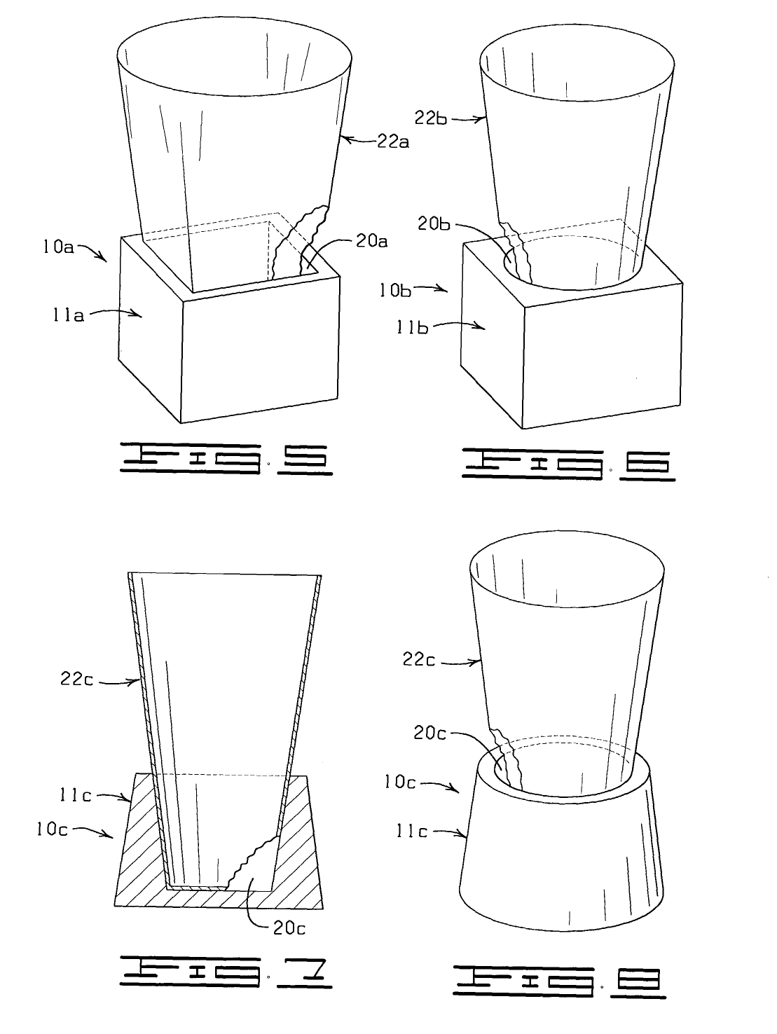

Shown in FIGS. 4 and 5 is another embodiment of a floral container of the present invention designated by the general reference numeral 10a. The floral container 10a comprises a holding material 11a and a liner 22a. The floral holding material 11a of the floral container 10a has a rectangular external shape and has a cavity 20a having a rectangular shape in cross-section.

Shown in FIG. 6 is a floral container 10b comprising a floral holding material 11b and a liner 22b. The floral holding material 11b has a rectangular external shape similar to that of floral container 10a, but the floral container 10b has an internal cavity 20b which has a cylindrical shape.

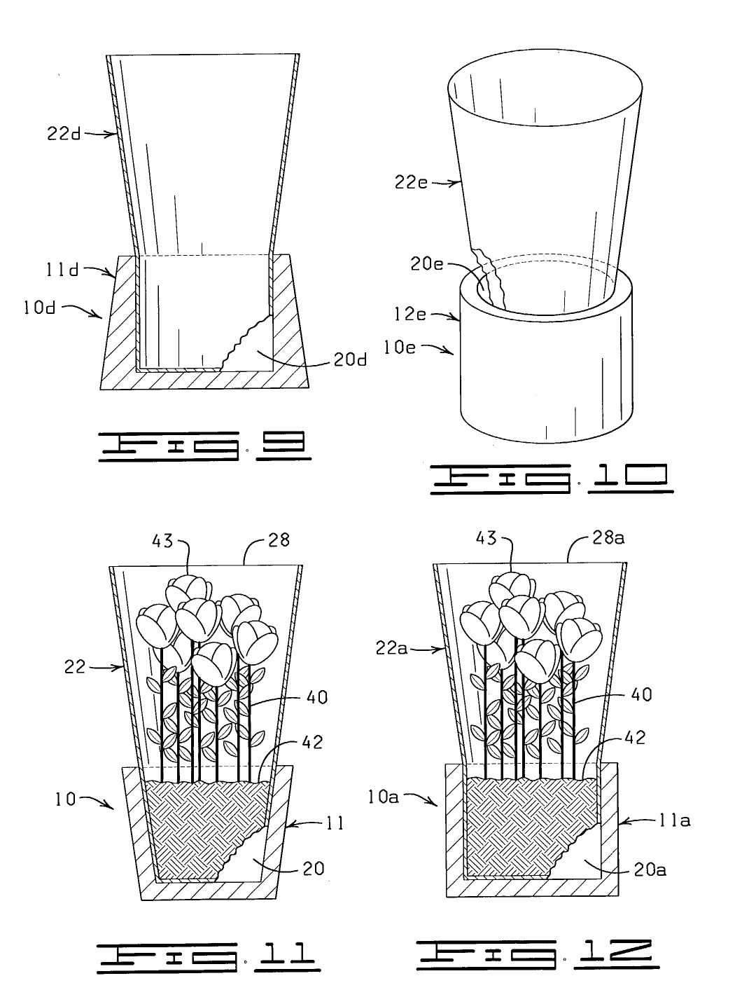

Shown in FIGS. 7 and 8 is another embodiment of a floral container of the present invention designated by the general reference numeral 10c. The floral container 10c comprises a floral holding material 11c and a liner 22c. The floral holding material 11c of the floral container 10c has a truncated frustoconical shape and an internal cavity 20c which has an inverted truncated frustoconical shape.

Shown in FIG. 9 is a floral container 10d comprising a floral holding material 11d and a liner 22d. The floral holding material 11d has an external shape similar to that of the floral holding material 11c of the floral container 10c in FIG. 7, but which has an internal cavity 20d which has a cylindrical shape. Similarly, one can envision a floral container similar to container 10c but which has a cavity having a truncated frustoconical shape (not shown).

Shown in FIG. 10 is a floral container 10e which comprises a floral holding material 11e and a liner 22e. The floral holding material 11e has a cylindrical shape and has a cavity 20e therein having a cylindrical shape.

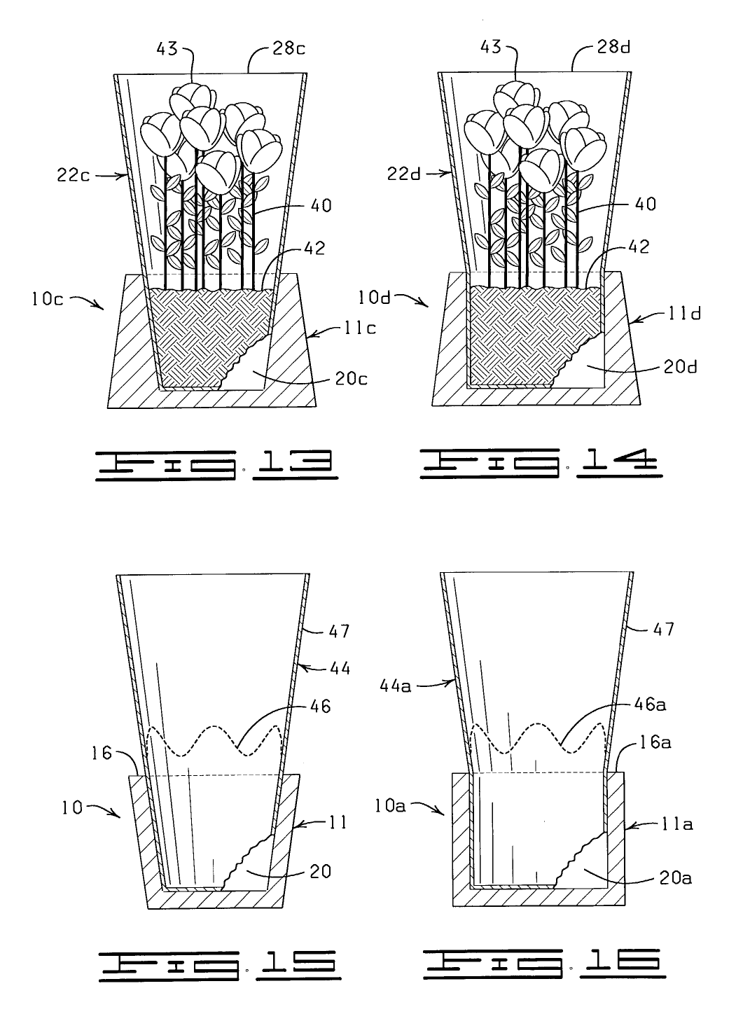

As described above, each of the floral containers 10-10e contemplated herein is designed for the purpose of containing a floral grouping. FIGS. 11-14 show a floral grouping 40 which is contained within floral containers 10, 10a, 10c, and 10d, respectively, wherein a potting material 42 is disposed in each liner 22, 22a, 22c and 22d which is disposed within the floral holding materials 11, 11a, 11c and 11d of the floral container 10, 10a, 10c, and 10d, respectively. The upper end 28 of the liner 22, and an upper end 28a, 28c and 28d of each of the liners 22a, 22c and 22d, respectively, is shown disposed a distance above an upper end 43 of the floral grouping 40; however, this is indicated only for the purposes of illustration. The upper end 28, 28a, 28c or 28d of the liners 22, 22a, 22c and 22d, respectively, does not necessarily extend above the upper end 43 of the floral grouping 40.

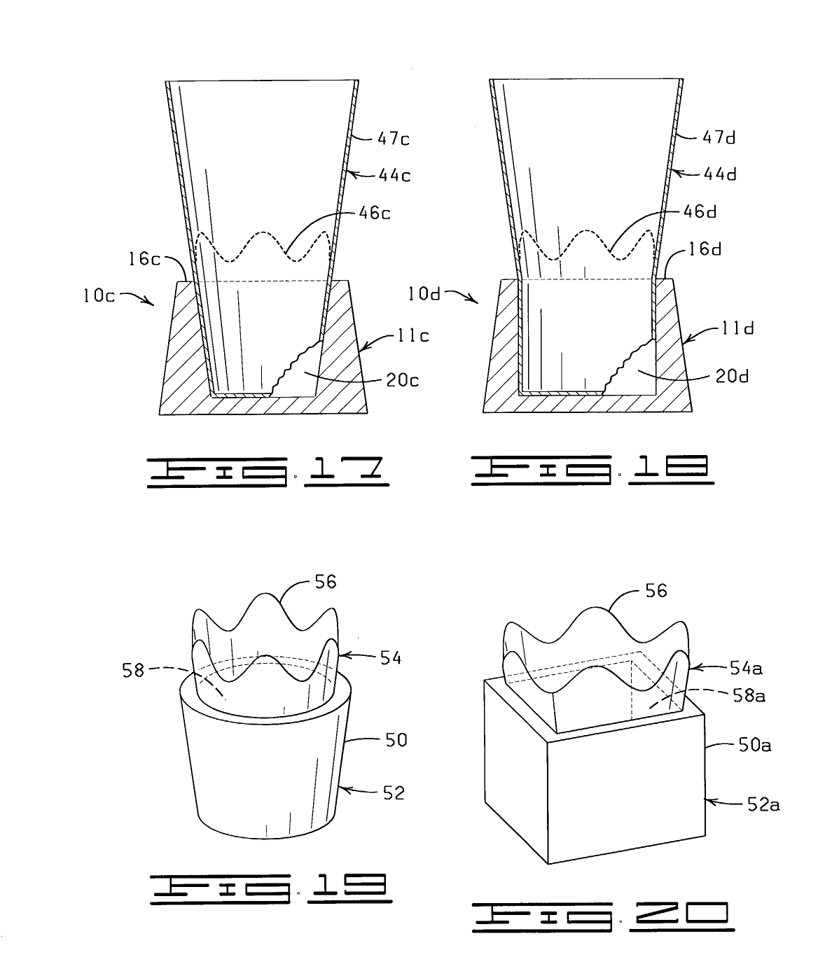

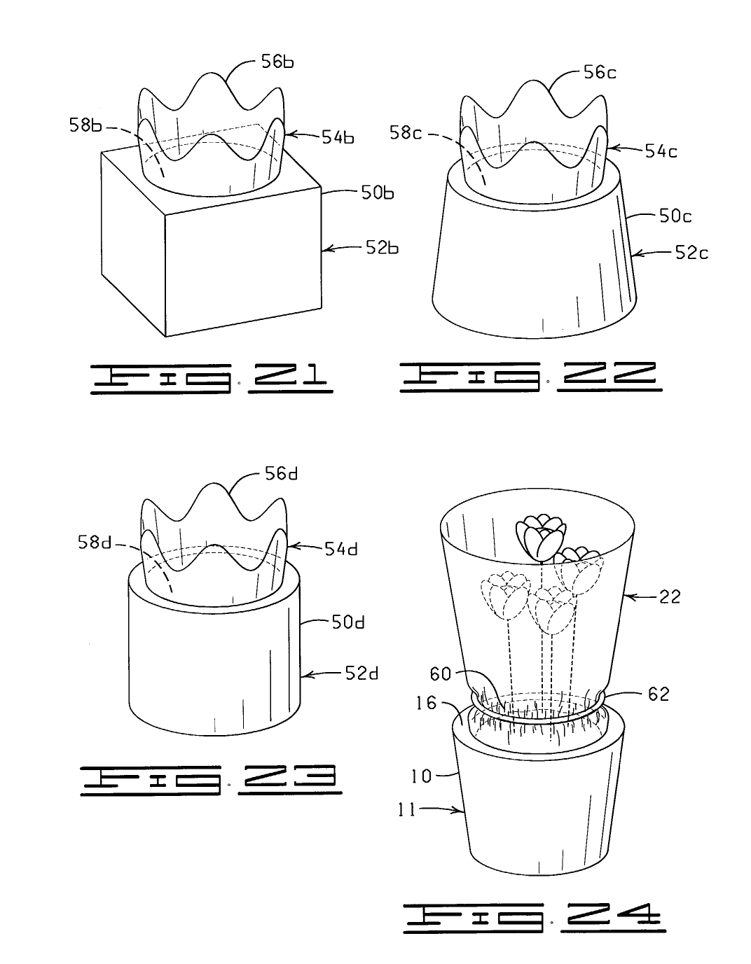

In yet another embodiment of the present invention as shown in FIGS. 15-18, a liner 44, 44a, 44c and 44d is disposed in the cavity 20, 20a, 20c and 20d of the floral holding material 11, 11a, 11c and 11d of the floral containers 10, 10a, 10c and 10d, respectively. The liners 44, 44a, 44c and 44d are provided with a pattern of perforations 46, 46a, 46c and 46d which are disposed at a position above the upper ends 16, 16a, 16c and 16d of the floral holding material 11, 11a, 11c and 11d of the floral containers 10, 10a, 10c and 10d, respectively. The perforations 46, 46a, 46c and 46d enable an upper portion 47, 47a, 47c and 47d of the liners 44, 44a, 44c and 44d to be removed after or before a floral grouping is disposed within the liners 44, 44a, 44c and 44d. The curved or non-linear pattern of the perforations 46, 46a, 46c and 46d is intended only as an illustration. It will be clear to a person of ordinary skill in the art that any other pattern of perforations, including linear, which is familiar to one of the ordinary skill in the art, may be used.

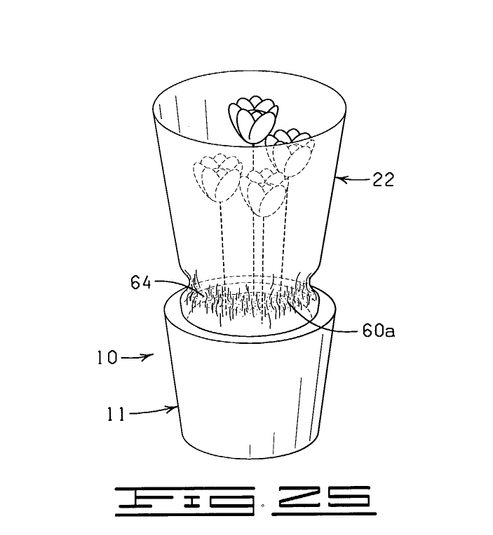

As shown in FIGS. 19-23, floral containers, 50, 50a, 50b, 50c and 50d comprise a floral holding material 52, 52a, 52b, 52c and 52d, respectively, and a liner 54, 54a, 54b, 54c and 54d, respectively. The floral holding materials 52, 52a, 52b, 52c and 52d are similar in construction as the floral holding materials 11, 11a, 11b, 11c and 11e hereinbefore described with reference to FIGS. 1-8 and 10. The liners 54, 54a, 54b, 54c and 54d are provided with a curved non-linear upper edge 56, 56a, 56b, 56c and 56d, respectively; and the liners 54, 54a, 54b, 54c and 54d are disposed in a cavity 58, 58a, 58b, 58c and 58d formed in the floral holding material 52, 52a, 52b, 52c and 52d, respectively, of the floral containers 50, 50a, 50b, 50c and 50d, respectively. The non-linear upper edge 56, 56a, 56b, 56c and 56d of the liners 54, 54a, 54b, 54c and 54d, respectively, shown in FIGS. 19-23 is shown by way of illustration only and it is not to be construed as limiting the decorative design which may be provided as the non-linear upper edge 56, 56a, 56b, 56c and 56d of the liners 54, 54a, 54b, 54c and 54d, respectively.

“Floral grouping” as used herein means a botanical item or propagule and may include other secondary plants and/or natural or synthetic ornamental materials which add to the aesthetics of the overall floral grouping.

The term “botanical item” as used herein means a natural or artificial herbaceous or woody plant, taken singly or in combination. The term “botanical item” also means any portion or portions of natural or artificial herbaceous or woody plants including stems, leaves, flowers, blossoms, buds, blooms, cones, or roots, taken singly or in combination, or in groupings of such portions such as bouquet or floral grouping.

When an impermeable external surface layer is provided on the outer surface of the floral holding material of the floral container, such as the outer surface 12 of the floral holding material 11 of the floral container 10, and/or the internal surface of the floral holding material defining the cavity in the internal surface, such as the internal surface 14 of the floral holding material 11, such an impermeable external surface layer may be composed of a material which could be permeated or destroyed by activation with a solvent or with microbes able to degrade the layer.

The floral containers 10-10e and 50-50d may include a reinforcing structure for providing support and reinforcement of the floral holding material such as shown in U.S. Pat. No. 5,410,856 or 5,402,599, both of which are hereby expressly incorporated herein by reference. The reinforcing material may be, for example, rods, or bars, or may be a mesh-like material which may be comprised of fibers or wire which may be of a plastic, metal or natural or synthetic fibrous composition.

As shown in FIGS. 11-14, the cavities 20-20e of the floral holding materials 11-11e of the floral containers 10-10e may be filled with the growing medium or potting material 42. Similarly, the cavities 58-58d of the floral holding materials 52-52d may be filled with such a growing medium or potting material. The term “growing medium” or “potting material” used herein means any liquid, solid or gelatinous material used for plant growth or for the cultivation of propagules, or merely for support of the floral grouping 40, including organic and inorganic materials such as soil, humus, perlite, vermiculite, sand, water, and which may include the nutrients, fertilizers or hormones or combinations thereof required by the plants or propagules for growth.

Each of the liners shown herein is constructed from any material suitable for its intended use. Preferably, the liners are constructed of a material selected from a group of materials consisting of paper, metal foil, natural or synthetic fabric or combinations thereof, denim, burlap, natural or synthetic polymer film or cling material or combinations thereof.

The term “polymer film” as used herein means any polymer film. For example, but not by way of limitation, one polymer film is a polypropylene film. Another example of a polymer film, but not by way of limitation, is cellophane.

The thickness of the material used in the construction of the liners employed in the practice of the present invention can vary widely. Generally, however, such lines will have a thickness in a range from about 0.1 mil to about 30 mils. Preferably, the liners will have a thickness in a range from about 0.1 mil to about 5 mils.

A decorative pattern, such as a color and/or an embossed pattern, and/or other decorative surface ornamentation may be applied to the outer surfaces of the floral holding materials, such as the outer surface 12 of the floral holding material 11 or to portions thereof; or to the liners or portions thereof, such as the liner 22-22e of the floral containers 10-10e herein before described. Such decorative pattern includes, but is not limited to, printed design, coatings, colors, flocking or metallic finishes. Further, the liners hereinbefore described may be totally or partially clear or tinted transparent material.

In yet another embodiment, a crimped portion may be formed in the liner 22 of the floral container 10 (or the other liners shown herein) by crimping together portions of the liner 22 to form a crimped portion 60 as shown in FIG. 24. The crimped portion 60 preferably extends circumferentially about the upper end 16 of the floral holding material 11 of the floral container 10, although the crimped portion 60 could be formed only in portions of the liner 22 thereby forming circumferentially spaced apart crimped portions if desired in a particular application.

The crimped portion 60 may be formed by placing a band 62 about a portion of the liner 22 with the band 62 gathering or bringing together portions of the liner 22 pulling portions thereof toward a central portion of the upper end 16 of the floral container 10 to form the crimped portion 60.

The term “band” as used herein means any material which may be secured about an object such as the liner 22, such bands commonly being referred to as elastic bands or rubber bands and also includes any other typed of material such as a string or elastic piece of material, non-elastic piece of material, a round piece of material, a flat piece of material, a ribbon, a piece of paper strip, a piece of plastic strip, a piece of wire, a tie wrap or a twist tie or combinations thereof or any other device capable of gathering the liner 22 to form the crimped portion 60. The band 62 also may include a bow if desired in a particular application.

Referring now to FIG. 25, a crimped portion 60a is formed in the liner 22 of the floral container 10 (or other liners shown herein) by crimping a portion of the liner 22 having an adhesive or cohesive bonding material 64 disposed thereon, wherein the crimped portion 60a comprises one or more overlapping connected portions.

In any of the various embodiments of the present invention, the floral holding materials 11-11e, and/or the liner 22-22e of the floral containers 10-10e or the floral holding material 52-52d, and/or the liner 54-54d may be decorated on their outer surface, or portions thereof, or the floral holding materials 11-11e or 52-52d may be molded, formed or otherwise treated to have a decorative form or shape or decorations thereon, such as inlays, intaglios or embossed portions.

Changes may be made in the construction and the operation of the various components, elements and assemblies described herein and changes may be made in the steps or the sequence of steps of the methods described herein without departing from the spirit and scope of the invention as defined in the following claims.

What is claimed is:

1. A floral container assembly, consisting essentially of:
a container constructed of a foam material, the container having an upper end, a lower end and an internally disposed cavity openly communicating with the upper end, the internally disposed cavity having an inner surface; and
a liner disposed within the internally disposed cavity of the container such that an upper portion of the liner extends a distance beyond the upper end of the container, and wherein the liner is not attached to the inner surface of the internally disposed cavity of the container.

2. The floral container assembly of claim 1 wherein the liner is selected from the group consisting of a sheet of material, a tubular sleeve and a preformed container having a plurality of connected overlapping folds.

3. The floral container assembly of claim 1 wherein the liner is further characterized as having a lower portion, and wherein the liner is provided with perforations for permitting the upper portion of the liner to be detached from the lower portion of the liner.

4. The floral container assembly of claim 1 wherein the liner has an upper end and the liner has bonding material positioned near the upper end thereof for permitting closure of the upper end of the liner.

5. The floral container assembly of claim 1 wherein the upper portion of the liner extending above the upper end of the container has a non-linear upper edge.
